(19) United States
(12) Patent Application Publication
(10) Pub. No.: US 2021/0084261 A1
(43) Pub. Date: Mar. 18, 2021

(54) VEHICLE-IMAGE CAPTURING SYSTEM

(71) Applicant: TOYOTA JIDOSHA KABUSHIKI KAISHA, Toyota-shi (JP)

(72) Inventors: Kazuya NISHIMURA, Anjo-shi (JP); Hirofumi KAMIMARU, Fukuoka-shi (JP)

(73) Assignee: TOYOTA JIDOSHA KABUSHIKI KAISHA, Toyota-shi (JP)

(21) Appl. No.: 17/022,749

(22) Filed: Sep. 16, 2020

(30) Foreign Application Priority Data
Sep. 17, 2019 (JP) 2019-168552

(51) Int. Cl. H04N 7/18; G06F 21/62; H04L 29/06

(52) U.S. Cl. CPC H04N 7/183; H04L 63/08; G06F 21/6218

(57) ABSTRACT

A vehicle-image capturing system includes a communication device provided on a first vehicle and configured to execute the processing of receiving an image capture request that requests capture of an image of the first vehicle and transmitting an image capture request signal containing information for identification of the first vehicle and information requesting capture of an image of the first vehicle to the outside of the first vehicle, and an image capture device provided outside the first vehicle and configured to execute the processing of receiving the image capture request signal, finding the first vehicle on the basis of the information for identification of the first vehicle contained in the image capture request signal, capturing an image of the first vehicle found, and sending the data of the captured image of the first vehicle to the communication device.

### CROSS REFERENCE TO RELATED APPLICATION

This application claims the benefit of Japanese Patent Application No. 2019-168552, filed on Sep. 17, 2019, which is hereby incorporated by reference herein in its entirety.

### BACKGROUND

### Technical Field

The present disclosure relates to a vehicle-image capturing system.

### Description of the Related Art

There are prevailing devices that record the front and rear views of vehicles, examples of which include driving recorders (dashcam). Vehicles equipped with such devices have also been developed (see, for example, Patent Literature 1 in the citation list below).

### CITATION LIST

### Patent Literature

Patent Literature 1: Japanese Patent Application Laid-Open No. 2019-050462

### SUMMARY

There are growing needs for captured images of vehicles in which users are riding. The present disclosure has been made to respond to such needs, and an object is to provide technology that is effective for efficient capturing of images of vehicles in which users are riding.

According to a first aspect of the present disclosure, there is provided, for example, a vehicle-image capturing system comprising:

a communication device provided on a first vehicle and configured to execute the processing of receiving an image capture request that requests capture of an image of the first vehicle and transmitting an image capture request signal containing information for identification of the first vehicle and information requesting capture of an image of the first vehicle to the outside of the first vehicle; and an image capture device provided outside the first vehicle and configured to execute the processing of receiving the image capture request signal, finding the first vehicle on the basis of the information for identification of the first vehicle contained in the image capture request signal, capturing an image of the first vehicle found, and sending the data of the captured image of the first vehicle to the communication device.

According to a second aspect of the present disclosure, there is provided, for example, a vehicle-image capturing system comprising:

a communication device provided on a first vehicle and configured to execute the processing of receiving an image capture request that requests capture of an image of the first vehicle and transmitting an image capture request signal containing information for identification of the first vehicle and information requesting capture of an image of the first vehicle to the outside of the first vehicle; and

an image capture device provided outside the first vehicle and configured to execute the processing of receiving the image capture request signal, finding the first vehicle on the basis of the information for identification of the first vehicle contained in the image capture request signal, capturing an image of the first vehicle found, sending the data of the captured image of the first vehicle to a predetermined server apparatus, and sending authentication information that is needed to retrieve the data of the image sent to the server apparatus to the communication device.

The present disclosure provides a technology that is effective for efficient capturing of images of vehicles in which users are riding.

### BRIEF DESCRIPTION OF THE DRAWINGS

FIG. 1 is a diagram illustrating the general configuration of a vehicle-image capturing system according to a first embodiment.

FIG. 2 is a diagram illustrating exemplary hardware configurations of a first on-vehicle apparatus and a second on-vehicle apparatus in the system according to the first embodiment.

FIG. 3 is a block diagram illustrating the functional configuration of the first on-vehicle apparatus in the system according to the first embodiment.

FIG. 4 is a block diagram illustrating the functional configuration of the second on-vehicle apparatus in the system according to the first embodiment.

FIG. 5 is a flow chart illustrating flows of data transmitted between components of the vehicle-image capturing system according to the first embodiment and processing performed by the components.

FIG. 6 is a diagram illustrating the general configuration of a vehicle-image capturing system according to a first modification of the first embodiment.

FIG. 7 is a diagram illustrating exemplary hardware configurations of a first on-vehicle apparatus and an image capturing device in the system according to the first modification of the first embodiment.

FIG. 8 is a block diagram illustrating the functional configuration of the image capturing device in the system according to the first modification of the first embodiment.

FIG. 9 is a flow chart illustrating flows of data transmitted between components of the vehicle-image capturing system according to the first modification of the first embodiment and processing performed by the components.

FIG. 10 is a block diagram illustrating the functional configuration of a second on-vehicle apparatus in the system according to a second modification of the first embodiment.

FIG. 11 is a diagram illustrating exemplary hardware configurations of components of a vehicle-image capturing system according to a second embodiment.

FIG. 12 is a block diagram illustrating the functional configuration of a first on-vehicle apparatus in the system according to the second embodiment.

FIG. 13 is a block diagram illustrating the functional configuration of a second on-vehicle apparatus in the system according to the second embodiment.

FIG. 14 is a block diagram illustrating the functional configuration of a server apparatus in the system according to the second embodiment.

FIG. 15 is a diagram illustrating an exemplary structure of an image information table.

FIG. 16 is a flow chart illustrating flows of data transmitted between components of the vehicle-image capturing system according to the second embodiment and processing performed by the components.

### DESCRIPTION OF THE EMBODIMENTS

What is disclosed here is a vehicle-image capturing system that captures an image of a vehicle in which a user is riding (which will be referred to as “the first vehicle”) by an image capturing device provided outside the first vehicle in response to a request for capturing an image of the vehicle (which will be referred to as “image capture request”) and provides image data acquired by the image capturing device directly or indirectly to the user of the first vehicle.

To capture an image of a vehicle in which a user is riding, it is necessary to prepare a photographer or image capturing equipment on the side of the road that the vehicle travels or other appropriate locations. So it is not easy to efficiently capture an image of the vehicle in which the user is riding.

The vehicle-image capturing system according to the present disclosure includes a communication device provided on a vehicle (first vehicle) in which a user is riding, and the communication device is configured to receive an image capture request. The image capture request is a request for capture of an image of the first vehicle. This image capture request is made by an operation on the communication device or other device performed by the user riding in the first vehicle. When the communication device receives the image capture request, it transmits an image capture request signal to the outside of the first vehicle. The image capture request signal contains information for identification of the first vehicle and information requesting capture of an image of the first vehicle. The information for identification of the first vehicle is information that enables an image capturing device to identify or find the first vehicle. Examples of the information for identification of the first vehicle include information about the model of the first vehicle, information about the body color of the first vehicle, and the numeric or alphanumeric ID on the vehicle registration plate (or license plate) of the first vehicle. The image capture request signal may be transmitted from the communication device by broadcast using short-range communication. Thus, image capturing devices located in the neighborhood of the first vehicle (i.e. ones located at locations from which an image of the first vehicle can be captured) can receive the image capture request signal transmitted from the communication device.

The image capture request signal transmitted from the communication device can be received by one or more image capturing devices provided outside the first vehicle. If an image capturing device receives the image capture request signal transmitted from the communication device, the image capturing device executes the processing of finding the first vehicle on the basis of the information for identification of the first vehicle contained in the image capture request signal. This information will also be referred to as “vehicle identification information” hereinafter. For example, the image capturing device may apply image recognition processing based on the vehicle identification information to image data acquired by it to find a vehicle that matches the vehicle identification information. If the image capturing device finds the first vehicle, it captures a still or moving image containing the first vehicle as the subject. Then, the image capturing device may send data of the captured image of the first vehicle directly to the communication device. This enables the user of the first vehicle to get the data of the captured image of the first vehicle immediately.

The image capturing deice may send the data of the captured image of the first vehicle via a certain server apparatus indirectly. For example, the image capturing device may upload the data of the captured image of the first vehicle to a certain server apparatus. Moreover, the image capturing device may send to the communication device authentication information needed for the user of the first vehicle to retrieve (view or download) the image data uploaded on the server apparatus. This allows the user of the first vehicle to retrieve the image data uploaded on the server apparatus by using the authentication information. This will prevent unauthorized retrieval of the image data of the first vehicle by a third person other than the user of the first vehicle. The above process enables reduction of the amount of data transmitted between the image capturing device and the communication device. Therefore, even when the communication device and the image capturing device are located outside the area in which broadband, high-speed wireless communications are available, the user of the first vehicle can get the image data of the first vehicle.

The image capturing device may send to the communication device information indicating the time when it will capture an image of the first vehicle. Then, the communication device may inform the occupant of the first vehicle (the user riding in the first vehicle) of the time of image capture on the basis of the information indicating the time of image capture. Thus, the user in the first vehicle can be aware of the time of image capture, and the user can take appropriate actions, such as posing for image capture.

The image capturing device may send to the communication device information indicating the location of the image capturing device. Then, the communication device may inform the user in the first vehicle of the location of the image capturing device on the basis of the information indicating the location of the image capturing device. Thus, the user in the first vehicle can be aware of from where an image of the first vehicle will be captured, and the user can take appropriate actions, such as posing adapted to the location from which an image is captured.

The image capture request signal transmitted from the communication device to the outside may further contain information designating capture of either a still image or a moving image and/or information designating the angle of image capture in addition to the information for identification of the first vehicle and the information requesting capture of an image of the first vehicle. This enables the user of the first vehicle to get image data tailored to his or her preferences.

The image capturing device used in this system may be provided on a second vehicle other than the first vehicle or provided on the side of the road the first vehicle travels. The image capturing device provided on the second vehicle can be constituted by, for example, a communication device and a camera that a driving recorder (dashcam) or the like has. The image capturing device provided on the roadside can be constituted by, for example, a fixed camera and a communication device.

Various information transmitted between the first vehicle (specifically, the communication device on the first vehicle) and the image capturing device may be transmitted via a server apparatus. For example, the communication device on the first vehicle may send the image capture request signal (or information requesting capture of an image of the first vehicle) to the server apparatus. In this case, a control unit of the server apparatus picks up an image capturing device located in an area in which an image of the first vehicle can be captured. Then, the control unit sends information for identification of the first vehicle (vehicle identification information) and a command to capture an image of the first vehicle to the image capturing device picked up as above. Thus, the image capturing device picked up as above can identify the first vehicle on the basis of the vehicle identification information and capture an image of the first vehicle pursuant to the aforementioned command. The control unit of the server apparatus causes the image capturing device to send data of the image of the first vehicle captured by the image capturing device to the server apparatus to get the image data. Then, the control unit of the server apparatus sends to the communication device authentication information needed to download the data of the image of the first vehicle from the server apparatus. Thus, the user of the first vehicle can download the image of the first vehicle by accessing the server apparatus with this authentication information. In the case where the image capturing device is one provided on a second vehicle, an incentive for capture of the image of the first vehicle may be given to the user of the second vehicle.

In the following, specific embodiments of the present disclosure will be described with reference to the drawings. The dimensions, materials, shapes, relative arrangements, and other features of the components that will be described in connection with the embodiments are not intended to limit the technical scope of the present disclosure only to them, unless otherwise stated.

### First Embodiment

In the following, a vehicle-image capturing system will be described as an embodiment of the present disclosure. When a user riding in a first vehicle makes a request for capturing an image, the vehicle-image capturing system captures an image of the first vehicle using an image capturing device provided in a second vehicle other than the first vehicle.

(General Description of Vehicle-Image Capturing System)

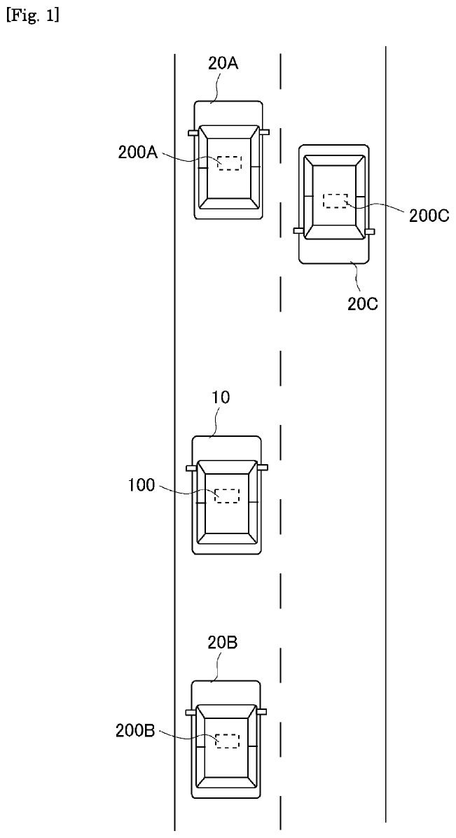

FIG. 1 is a diagram illustrating the general configuration of the vehicle-image capturing system. The vehicle-image capturing system according to this embodiment includes a first on-vehicle apparatus 100 provided on a first vehicle 10, and second on-vehicle apparatuses 200A, 200B, 200C provided on second vehicles 20A, 20B, 20C other than the first vehicle 10. While FIG. 1 shows three second vehicles 20A, 20B, 20C, the number of second vehicles is not limited to three.

The first vehicle 10 is a vehicle in which a user who wishes image capture is riding. The second vehicles 20A, 20B, 20C are vehicles other than the first vehicle 10 each of which is provided with a device capable of capturing images of the outside of the second vehicle 20 (e.g. the front view, rear view, and/or side view). The second vehicles 20A, 20B, 20C will also be collectively referred to as “second vehicle(s) 20”.

The first on-vehicle apparatus 100 provided on the first vehicle 10 and the second on-vehicle apparatus 200 provided on the second vehicle 20 can be connected to a network by wireless communication. Examples of the wireless communication include mobile communications, such as 5G mobile communications or LTE (Long Term Evolution) mobile communications, narrow-band communications, such as DSRC (Dedicated Short Range Communications), and WiFi (registered trademark). The network may be, for example, a WAN (Wide Area Network), which may be a global public communication network such as the Internet, or other communication network. The first on-vehicle apparatus 100 and the second on-vehicle apparatuses 200 can be connected to each other by short-range communication having a communication range shorter than a specific distance. Thus, the first on-vehicle apparatus 100 can send an image capture request signal only to second vehicles 20 that are located within the specific distance from the first vehicle 10.

The first on-vehicle apparatus 100 is a device that serves as the communication device according to the present disclosure. The first on-vehicle apparatus 100 transmits an image capture request signal by broadcast using the short-range communication, when an image capture request is made by the user of the first vehicle (i.e. the occupant riding in the first vehicle 10). The image capture request signal is a signal containing information for identification of the first vehicle 10 (or vehicle identification information) and information requesting capture of an image containing the first vehicle 10 as the subject.

The second on-vehicle apparatus 200 is a device that serves as the image capturing device according to the present disclosure. When receiving the image capture request signal from the first on-vehicle apparatus 100, the second on-vehicle apparatus 200 finds the first vehicle 10 on the basis of the vehicle identification information and captures an image of the first vehicle 10 thus found. Moreover, the second on-vehicle apparatus 200 sends data of the captured image of the first vehicle 10 to the first on-vehicle apparatus 100. The second on-vehicle apparatus 200 may send the image data to the first on-vehicle apparatus 100 by short-range communication. When the first vehicle 10 and the second vehicle 20 are both running, there is a possibility that the distance between the first vehicle 10 and the second vehicle 20 may become larger than the specific distance (the communication range of the short-range communication) after the image capture of the first vehicle. In view of this, the image data may be sent from the second on-vehicle apparatus 200 to the first on-vehicle apparatus 100 via the network.

(Hardware Configuration)

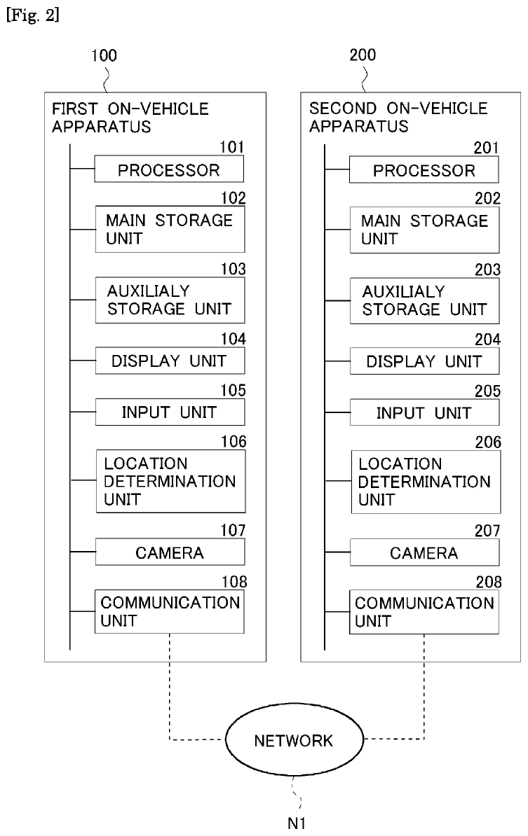

FIG. 2 is a diagram illustrating exemplary hardware configurations of the first on-vehicle apparatus 100 and the second on-vehicle apparatus 200.

An example of the first on-vehicle apparatus 100 is a car navigation system that can be connected to the network N1 by wireless communication. Another example of the first on-vehicle apparatus 100 is a personal computer (PC) that can be connected to the network N1 by wireless communication. Still another example of the first on-vehicle apparatus 100 is a small-size computer that the user of the first vehicle 10 can carry. Examples of such a small-size computer include a smartphone, a cellular phone, a tablet terminal, a personal information terminal, and a wearable computer (such as a smartwatch).

As illustrated in FIG. 2, the first on-vehicle apparatus 100 has a processor 101, a main storage unit 102, an auxiliary storage unit 103, a display unit 104, an input unit 105, a location determination unit 106, a camera 107, and a communication unit 108. These components are interconnected by buses. The main storage unit 102 and the auxiliary storage unit 103 are computer-readable recording media. The hardware configuration of the first on-vehicle apparatus 100 is not limited to that illustrated in FIG. 2, but some of its components may be eliminated or replaced, and/or other components may be added.

The processor 101 of the first on-vehicle apparatus 100 loads programs stored in a recording medium into a workspace of the main storage unit 102 and executes the programs to control various functional components. Thus, the first on-vehicle apparatus 100 implements functions for achieving desired purposes.

The processor 101 may be, for example, a CPU (Central Processing Unit) or a DSP (Digital Signal Processor). The processor 101 controls the first on-vehicle apparatus 100 and executes computation of various information processing. The main storage unit 102 includes, for example, a RAM (Random Access Memory) and/or a ROM (Read Only Memory). The auxiliary storage unit 103 may include an EPROM (Erasable Programmable ROM) or a hard disk drive (HDD). The auxiliary storage unit 103 may include a removable medium, in other words, a portable recording medium. Examples of the removable medium include a USB (Universal Serial Bus) memory and disc recording media, such as a CD (Compact Disc) and a DVD (Digital Versatile Disc).

The auxiliary storage unit 103 can store various programs, various data, and various tables, which can be written into and read out from the auxiliary storage unit 103 when necessary. The auxiliary storage unit 103 may store an operating system (OS). All or a portion of the aforementioned information or data stored in the auxiliary storage unit 103 may be stored in the main storage unit 102 instead. Likewise, information or data stored in the main storage unit 102 may be stored in the auxiliary storage unit 103 instead.

The display unit 104 may be, for example, a liquid crystal display (LCD), an electroluminescence (EL) panel, or the like. The input unit 105 may include, for example, a touch panel or push buttons used to input alphanumeric characters and/or a microphone used to input voices. The location determination unit 106 is a device capable of determining the present location of the first on-vehicle apparatus 100 (that is, the present location of the first vehicle 10), which typically includes a GPS receiver.

The camera 107 is image capturing equipment capable of capturing images of the inside and/or the outside of the first vehicle 10 (e.g. the front, rear, and/or side view from the first vehicle 10). The camera 107 may be either one capable of capturing moving images or one capable of capturing still images. The camera 107 is controlled by the processor 101 by executing a computer program on the main storage unit 102. The camera 107 may be caused to operate while the first vehicle 10 is operating (e.g. while the ignition switch thereof is on) to serve as a driving recorder (dashcam). The camera 107 may also be caused to operate while the first vehicle 10 is parked to serve as a surveillance camera. The camera 107 is not the essential component of the first vehicle 10.

The communication unit 108 is a communication circuit capable of accessing the network N1 using wireless communication provided by a mobile communication service or other means to allow data communications with external devices including the second on-vehicle apparatuses 200. The communication unit 108 in the system according to the embodiment also has the function of transmitting signals by broadcast using short-range communication. Examples of the short-range communication include data communications based on various communication standards, such as Bluetooth LowEnergy (BLE), NFC (Near Field Communication), UWB (Ultra Wideband), and Wi-Fi. (Bluetooth is a registered trademark.)

Various processing executed in the first on-vehicle apparatus 100 configured as above may be executed by either hardware or software.

An example of the second on-vehicle apparatus 200 is a car navigation system provided on the second vehicle 20 that can be connected to the network N1 by wireless communication. Another example of the second on-vehicle apparatus 200 is a personal computer (PC) that can be connected to the network N1 by wireless communication. Still another example of the second on-vehicle apparatus 200 is a small-size computer that the user of the second vehicle 10 can carry. Examples of such a small-size computer include a smartphone, a cellular phone, a tablet terminal, a personal information terminal, and a wearable computer (such as a smartwatch).

As illustrated in FIG. 2, the second on-vehicle apparatus 200 has a processor 201, a main storage unit 202, an auxiliary storage unit 203, a display unit 204, a location determination unit 206, a camera 207, and a communication unit 208. The processor 201, the main storage unit 202, the auxiliary storage unit 203, the display unit 204, the input unit 205, the location determination unit 206, the camera 207, and the communication unit 208 of the second on-vehicle apparatus 200 are the same as the processor 101, the main storage unit 102, the auxiliary storage unit 103, the display unit 104, the location determination unit 106, the camera 107, and the communication unit 108 of the first on-vehicle apparatus 100 and will not be described further.

(Functional Configuration of First On-Vehicle Apparatus)

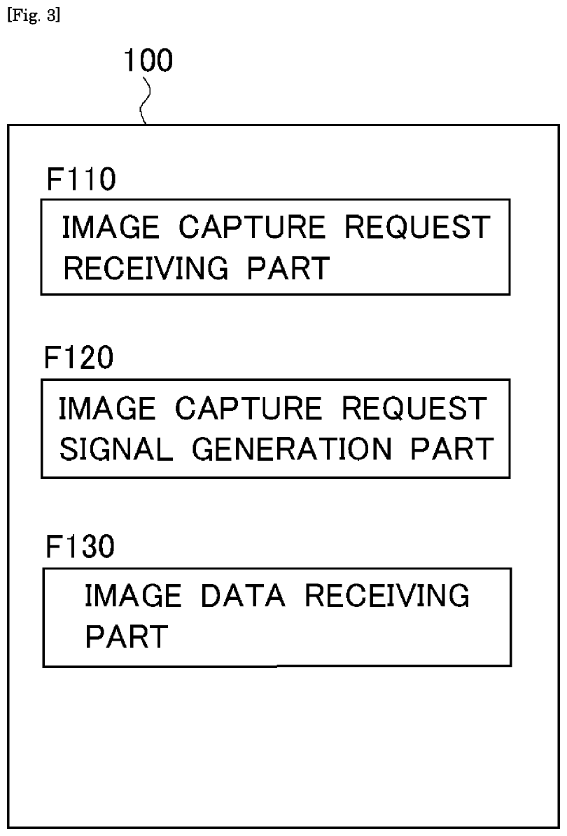

The functional configuration of the first on-vehicle apparatus 100 will now be described with reference to FIG. 3. As illustrated in FIG. 3, the first on-vehicle apparatus 100 according to this embodiment has, as functional components, an image capture request receiving part F110, an image capture request signal generation part F120, and an image data receiving part F130. The image capture request receiving part F110, the image capture request signal generation part F120, and the image data receiving part F130 are implemented by the processor 101 of the first on-vehicle apparatus 100 by executing computer programs on the main storage unit 102. One or some of the image capture request receiving part F110, the image capture request signal generation part F120, and the image data receiving part F130 may be implemented entirely or partly by one or more hardware circuits. One or some of the image capture request receiving part F110, the image capture request signal generation part F120, and the image data receiving part F130 or a part of the processing of them may be implemented by another computer or other computers connected to the network N1. For example, the processing executed as the image capture request receiving part F110, the processing executed as the image capture request signal generation part F120, and the processing executed as the image data receiving part F130 may be executed by different computers.

The image capture request receiving part F110 is configured to receive an image capture request made by the user through the input unit 105. The image capture request in the system according to the present disclosure is a request for capture of an image of the first vehicle 10 with the user riding in it from the outside. The image capture request as such is made by, for example, an operation on the input unit 105 performed by the user riding in the first vehicle 10. The input unit 105 may be provided with an image capture request button that is operated by the user of the first vehicle 10 to make the image capture request. The image capture request button may be either a button displayed on a touch panel display or a mechanical button. The image capture request received by the image capture request receiving part F110 is transferred to the image capture request signal generation part F120.

The image capture request signal generation part F120 is configured to generate an image capture request signal. The image capture request signal contains vehicle identification information for identification of the first vehicle 10 and information requesting capture of an image of the first vehicle. As described before, the vehicle identification information is information needed for an external device to find the first vehicle 10. The vehicle identification information used in the system according to this embodiment is the numeric or alphanumeric characters read on the vehicle registration plate of the first vehicle. Alternatively, the vehicle identification information may be information about the model of the first vehicle or information about the color of the first vehicle. The information requesting capture of an image of the first vehicle 10 may include information designating capture of a still image or a moving image and/or information designating the angle of image capture (e.g. image capture from front, side, or rear). The image capture request signal generated by the image capture request signal generation part F120 is transmitted by the communication unit 108 to the outside of the first vehicle 10 by broadcast. If the image capture request signal is transmitted by broadcast through the network N1, there is a possibility that the image capture request signal may be delivered not only to second vehicles 20 (or second on-vehicle apparatuses 200) located in the area within a certain distance from the first vehicle 10 (namely, second vehicles 20 at locations from which an image of the first vehicle 10 can be captured) but also second vehicles 20 (or second on-vehicle apparatuses 200) located at remote locations from which an image of the first vehicle 10 cannot be captured. To avoid this, the first on-vehicle apparatus 100 in the system according to this embodiment is configured to transmit the image capture request signal by broadcast using short-range communication. In consequence, the image capture request signal will reach only to second vehicles 20 (or second on-vehicle apparatuses 200) that are located in the area within a certain distance from the first vehicle 10.

The image data receiving part F130 is configured to receive data of an image of the first vehicle 10 captured by a second on-vehicle apparatus 200 having received the image capture request signal through the communication unit 108. The image data received by the image data receiving part F130 is stored in the auxiliary storage unit 103 or other storage means. When receiving the image data sent from the second on-vehicle apparatus 200, the image data receiving part F130 may inform the user of the first vehicle 10 of the reception. For example, when receiving the image data sent from the second on-vehicle apparatus 200, the image data receiving part F130 may display a message indicating the reception of the image data on the display unit 104 or cause a speaker provided in the vehicle 10 to generate a sound.

(Functional Configuration of Second On-Vehicle Apparatus)

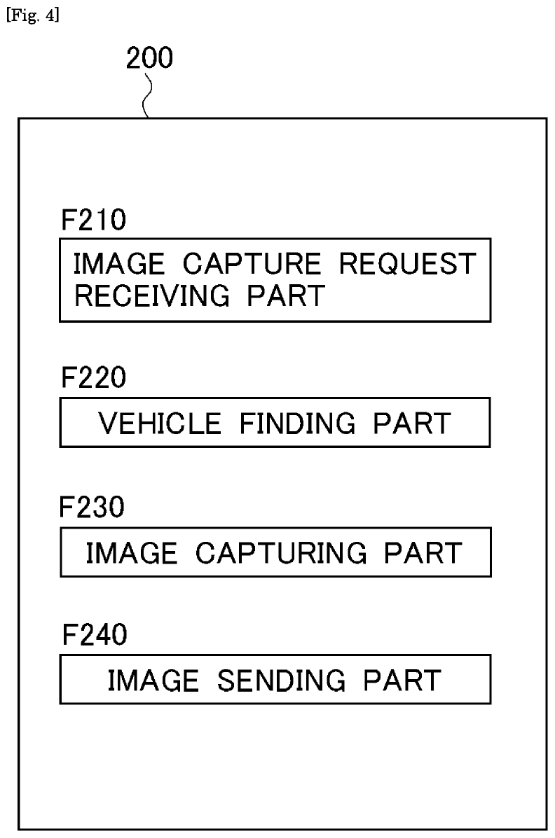

The functional configuration of the second on-vehicle apparatus 200 will now be described with reference to FIG. 4. As illustrated in FIG. 4, the second on-vehicle apparatus 200 according to this embodiment has, as functional components, an image capture request receiving part F210, a vehicle finding part F220, an image capturing part F230, and an image sending part F240. The image capture request receiving part F210, the vehicle finding part F220, the image capturing part F230, and the image sending part F240 are implemented by the processor 201 of the second on-vehicle apparatus 200 by executing computer programs on the main storage unit 202. One or some of the image capture request receiving part F210, the vehicle finding part F220, the image capturing part F230, and the image sending part F240 may be implemented entirely or partly by one or more hardware circuits. One or some of the image capture request receiving part F210, the vehicle finding part F220, the image capturing part F230, and the image sending part F240 or a part of the processing of them may be implemented by another computer or other computers connected to the network N1. For example, the processing executed as the image capture request receiving part F210, the processing executed as the vehicle finding part F220, the processing executed as the image capturing part F230, and the processing executed as the image sending part F240 may be executed by different computers.

The image capture request receiving part F210 is configured to receive the image capture request signal transmitted from the first on-vehicle apparatus 100 through the communication unit 208. The vehicle identification information contained in the image capture request signal is transferred from the image capture request receiving part F210 to the vehicle finding part F220.

The vehicle finding part F220 is configured to execute the processing of finding the first vehicle 10 on the basis of the vehicle identification information transferred from the image capture request receiving part F210. For example, the vehicle finding part F220 applies image recognition processing to image data captured by the camera 207 on the basis of the vehicle identification information (i.e. the numeric or alphanumeric characters on the vehicle registration plate of the first vehicle) to find the vehicle that matches the vehicle identification information (that is, the first vehicle 10). Information about the first vehicle 10 found by the vehicle finding part F220 is transferred to the image capturing part F230.

The image capturing part S230 is configured to execute the processing of capturing an image containing the first vehicle 10 found by the vehicle finding part F220 as the subject. For example, the image capturing part F230 captures an image by the camera 207 while focusing it on the first vehicle 10. When the image capture request signal contains information designating capture of a still image or a moving image and/or information designating the angle of image capture, the image capturing part F230 captures an image of the first vehicle 10 in accordance with the designated conditions. When capturing an image of the first vehicle 10, the image capturing part F230 may send to the first on-vehicle apparatus 100 information notifying the start of image capturing (or information indicating the time when image capture will be performed) and/or information indicating the location of the second vehicle 20 etc. Then, the first on-vehicle apparatus 100 may inform the user of the first vehicle 10 of the time when image capture will be performed and the location of the second vehicle 20 by, for example, displaying a message on the display unit 104 or outputting a voice message through a speaker. This enables the user of the first vehicle 10 to be aware of the time of image capture and the location from which an image is captured, allowing the user to take appropriate actions, such as posing for image capture. The data of the image of the first vehicle 10 acquired by the image capturing part F30 is transferred to the image sending part F240.

The image sending part F240 sends the image data transferred from the image capturing part F230 to the first on-vehicle apparatus through the communication unit 208. In doing so, the image sending part F240 sends the image data through the network N1. Therefore, even when the distance between the first vehicle 10 and the second vehicle 20 becomes larger than the aforementioned specific distance after the capture of the image of the first vehicle 10, the image data can be sent from the second on-vehicle apparatus 200 to the first on-vehicle apparatus 100.

(Procedure of Processing)

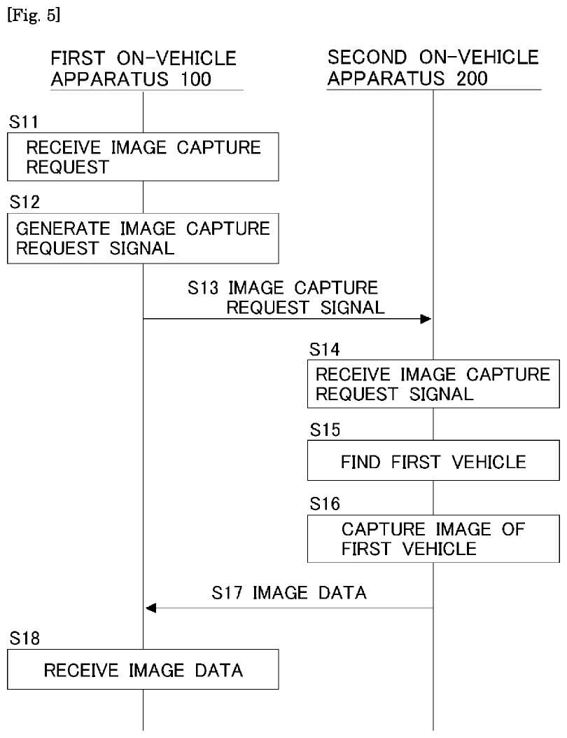

The procedure of processing performed by the first on-vehicle apparatus 100 and the second on-vehicle apparatus 200 in the system according to the embodiment will now be described with reference to FIG. 5. FIG. 5 is a flow chart illustrating flows of data transmitted between the components of the vehicle-image capturing system and processing performed by them.

Referring to FIG. 5, when the image capture request receiving part F110 of the first on-vehicle apparatus 100 receives an image capture request made by the user riding in the first vehicle 10 (step S11), the image capture request signal generation part F120 of the first on-vehicle apparatus 100 generates an image capture request signal (step S12). As described above, the image capture request signal contains information for identification of the first vehicle 10 (or vehicle identification information) and information requesting capture of an image of the first vehicle 10. The image capture request signal may further contain information designating capture of either a still image or a moving image and/or information designating the angle of image capture in addition to the above information.

The image capture request signal generated by the image capture request signal generation part F120 is transmitted to the outside of the first vehicle 10 through the communication unit 108 (step S13). Specifically, the communication unit 108 transmits the image capture request signal by broadcast by short-range communication. In consequence, the image capture request signal transmitted from the first on-vehicle apparatus 100 is received only by the second on-vehicle apparatuses 200 that are located in an area within a specific distance from the first vehicle 10 (namely, the second on-vehicle apparatuses that are located at locations from which an image of the first vehicle 10 can be captured).

In a second vehicle 20 located in the area within the specific distance from the first vehicle 10, when the communication unit 208 of the second on-vehicle apparatus 200 receives the image capture request signal (step S14), the image capture request receiving part F210 transfers the vehicle identification information contained in the image capture request signal to the vehicle finding part F220. The vehicle finding part F220 finds the first vehicle 10 on the basis of the vehicle identification information (step S15). Specifically, as described above, the vehicle finding part F220 applies image recognition processing to image data captured by the camera 207 on the basis of the vehicle identification information to find the vehicle that matches the vehicle identification information (i.e. the first vehicle 10). The method of finding the first vehicle 10 is not limited to this. For example, the first vehicle 10 may be configured to transmit an infrared signal uniquely associated with it, and the second vehicle 20 may find the first vehicle 10 by detecting this infrared signal. In this case, the vehicle identification information may be information identifying this infrared signal.

When the first vehicle 10 is found by the vehicle finding part F220 of the second on-vehicle apparatus 200, the image capturing part F230 focuses the camera 207 on the first vehicle 10 and captures an image by the camera 207 (step S16). In the case where the image capture request signal contains information designating capture of a still image or a moving image and/or information designating the angle of image capture, the image capturing part F230 captures an image of the first vehicle 10 in accordance with the designated conditions. When capturing an image of the first vehicle 10, the image capturing part F230 may send a notification of the start of image capture and information about the location of the second vehicle 20 to the first on-vehicle apparatus 100. Then, the first on-vehicle apparatus 100 can inform the user of the first vehicle 10 of the time of image capture and the location of the second vehicle 20. In consequence, the user of the first vehicle 10 can be aware of the time of image capture and the location from which an image is captured.

The data of the image of the first vehicle 10 captured by the image capturing part F230 is sent to the first on-vehicle apparatus 100 by the image sending part F240 (step S17). The image sending part F240 in the system according to this embodiment sends the image data of the first vehicle 10 to the first on-vehicle apparatus 100 through the network N1. The image sending part F240 may send the image data of the first vehicle 10 to the first on-vehicle apparatus either after the image capturing part F230 completes capturing an image of the first vehicle 10 or while the image capturing part F230 is capturing an image of the first vehicle 10 in real time.

In the first vehicle 10, when the communication unit 108 of the first on-vehicle apparatus 100 receives image data sent from the second on-vehicle apparatus 200 (step S18), the image data receiving part F130 stores the image data in the auxiliary storage unit 103 or other storage means. Then, the image data receiving part F130 may inform the user of the first vehicle 10 of the reception of image data from the second on-vehicle apparatus 200. This enables the user of the first vehicle 10 to know the acquisition of the image data of the first vehicle 10.

By the above-described process according to the flow chart in FIG. 5, the vehicle-image capturing system can capture an image of the first vehicle 10 with the user aboard (e.g. an image of the first vehicle 10 during running) from outside without effort of preparing a photographer or image capturing equipment on the roadside of the route of travel and provide data of the captured image to the user of the first vehicle 10.

As above, the vehicle-image capturing system according to the first embodiment can capture an image of the first vehicle 10 with the user aboard and provide data of the captured image to the user of the first vehicle 10 quickly. Moreover, the user of the first vehicle 10 may designate capture of either a still image or a moving image and the angle of image capture so that he or she can obtain an image tailored to his/her preferences.

### First Modification of First Embodiment

Next, a first modification of the above-described first embodiment will be described. The components and the processing steps that are substantially the same as those in the first embodiment will not be described in detail.

While the above-described vehicle-image capturing system according to the first embodiment uses the camera 207 provided on the second vehicle 20 at a location near the first vehicle 10 to capture an image of the first vehicle 10 from outside, a system according to the first modification uses an image capturing device (e.g. fixed camera) provided on the side of the road that the first vehicle 10 travels or at a location from which an image of the first vehicle 10 can be captured to capture an image of the first vehicle 10 from outside.

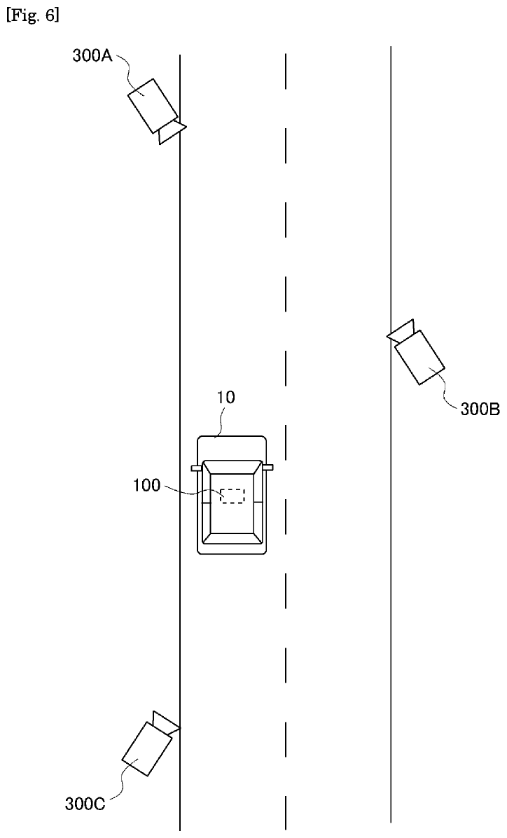

FIG. 6 is diagram illustrating the general configuration of a vehicle-image capturing system according to the first modification of the first embodiment. The vehicle-image capturing system according to the first modification includes a first on-vehicle apparatus 100 provided on a first vehicle 10 and image capturing devices 300A, 300B, 300C provided, for example, by the side of the road that the first vehicle 10 travels. While FIG. 6 shows three image capturing devices 300A, 300B, 300C, the number of image capturing device is not limited to three.

The image capturing devices 300A, 300B, 300C (which will also be collectively referred to as the image capturing devices 300) are devices provided on the side of the road that the first vehicle 10 travels and capable of capturing images of vehicles that travel the road. The first on-vehicle apparatus 100 and the image capturing devices 300 can be connected to a network by wireless communication. The first on-vehicle apparatus 100 and the image capturing devices 300 can be connected to each other by short-range communication having a communication range shorter than a specific distance. Thus, the first on-vehicle apparatus 100 can send an image capture request signal only to image capturing devices 300 that are located within the specific distance from the first vehicle 10.

When receiving the image capture request signal transmitted from the first on-vehicle apparatus 100, the image capturing device 300 finds the first vehicle 10 on the basis of the vehicle identification information and capture an image of the first vehicle 10 thus found. Moreover, the image capturing device 300 sends data of the captured image of the first vehicle 10 to the first on-vehicle apparatus 100. The image capturing device 300 may send the image data to the first on-vehicle apparatus 100 by short-range communication. However, when the first vehicle 10 is running, there is a possibility that the distance between the first vehicle 10 and the image capturing device 300 may become larger than the specific distance. In view of this, the image data may be sent from the image capturing device 300 to the first on-vehicle apparatus 100 via a network.

(Hardware Configuration)

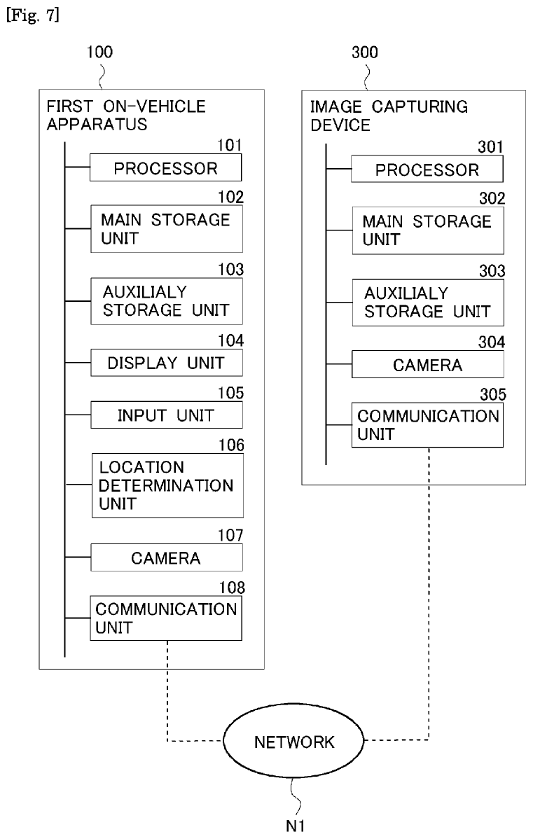

FIG. 7 is a diagram illustrating exemplary hardware configurations of the first on-vehicle apparatus 100 and the image capturing device 300. The hardware configuration of the first on-vehicle apparatus 100 is the same as that in the first embodiment and will not be described further.

The image capturing device 300 is, for example, a fixed camera system that can be connected to the network N1 by wireless communication. As illustrated in FIG. 7, the image capturing device 300 as such has a processor 301, a main storage unit 302, an auxiliary storage unit 303, a camera 304, and a communication unit 305. The processor 301, the main storage unit 302, the auxiliary storage unit 303, and the communication unit 305 are similar to the processor 101, the main storage unit 102, the auxiliary storage unit 103, and the communication unit 108 of the first on-vehicle apparatus 100 and will not be described further. The camera 304 is image capturing equipment used to capture images of vehicles travelling the road near the image capturing device 300. The camera 304 may be either one capable of capturing moving images or one capable of capturing still images. The camera 304 is controlled by the processor 301 by executing a computer program on the main storage unit 102. Various processing executed in the image capturing device 300 configured as above may be executed by either hardware or software.

(Functional Configuration of First On-Vehicle Apparatus)

The functional configuration of the first on-vehicle apparatus 100 is the same as that in the first embodiment and will not be described further.

(Functional Configuration of the Image Capturing Apparatus)

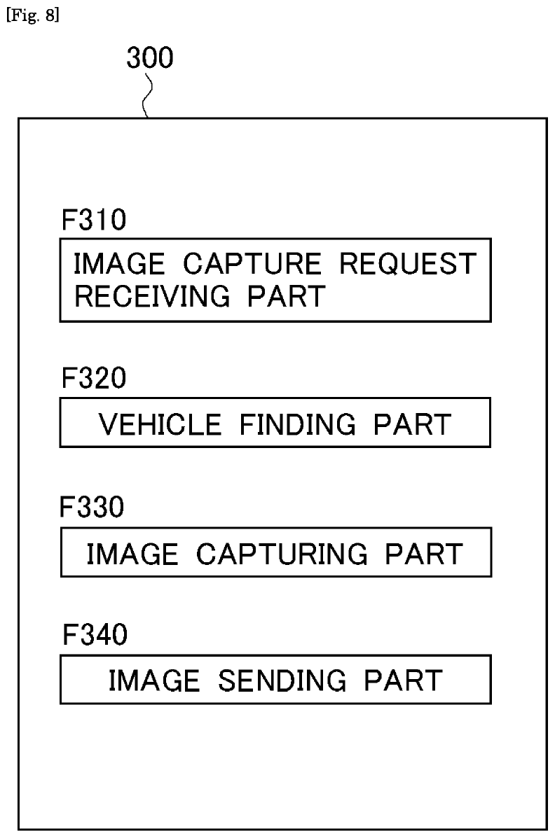

The functional configuration of the image capturing apparatus 300 will now be described with reference to FIG. 8. As illustrated in FIG. 8, the image capturing apparatus 300 in the system according to the first modification has, as functional components, an image capture request receiving part F310, a vehicle finding part F320, an image capturing part F330, and an image sending part F340. The image capture request receiving part F310, the vehicle finding part F320, the image capturing part F330, and the image sending part F340 are implemented by the processor 301 of the image capturing device 300 by executing computer programs on the main storage unit 302. One or some of the image capture request receiving part F310, the vehicle finding part F320, the image capturing part F330, and the image sending part F340 may be implemented entirely or partly by one or more hardware circuits. One or some of the image capture request receiving part F310, the vehicle finding part F320, the image capturing part F330, and the image sending part F340 may be implemented entirely or partly by another computer or other computers connected to the network N1. For example, the processing executed as the image capture request receiving part F310, the processing executed as the vehicle finding part F320, the processing executed as the image capturing part F330, and the processing executed as the image sending part F340 may be executed by different computers.

The functions of the image capture request receiving part F310, the vehicle finding part F320, the image capturing part F330, and the image sending part F340 are similar to the image capture request receiving part F210, the vehicle finding part F220, the image capturing part F230, and the image sending part F240 and will not described further.

(Procedure of Processing)

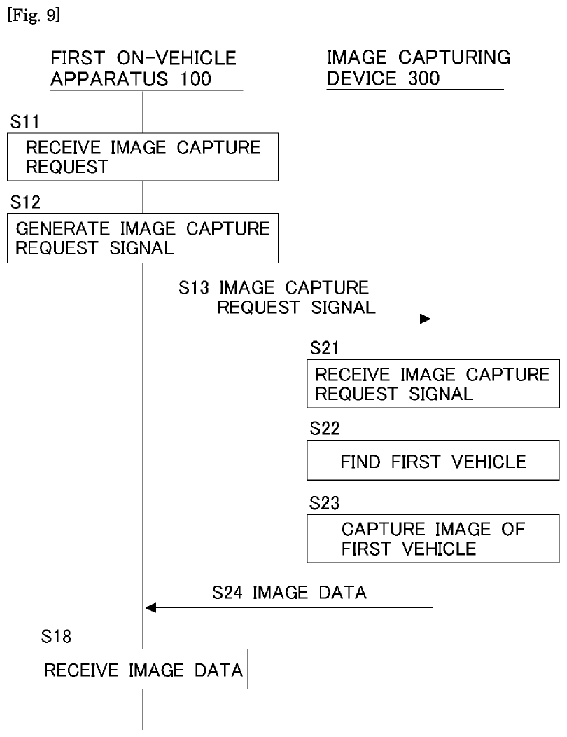

The procedure of processing performed by the first on-vehicle apparatus 100 and the image capturing device 300 in the system according to this modification will now be described with reference to FIG. 9. FIG. 9 is a flow chart illustrating flows of data transmitted between the components of the vehicle-image capturing system and processing performed by them. In FIG. 9, the steps of processing that are the same as those in the flow chart in FIG. 5 are denoted by the same reference signs and will not be described further.

Referring to FIG. 9, when the communication unit 305 of an image capturing device 300 provided in an area within a specific distance from the first vehicle 10 receives an image capture request signal (step S21), the image capture request signal receiving part F310 transfers the vehicle identification information contained in the image capture request signal to the vehicle finding part F320. Then, the vehicle finding part F320 finds the first vehicle 10 on the basis of the vehicle identification information (step S22). The method that is employed by the vehicle finding part F320 to find the first vehicle 10 is similar to the method that is employed by the vehicle finding part F220 of the second on-vehicle apparatus 200 in the first embodiment described above.

When the first vehicle 10 is found by the vehicle finding part F320 of the image capturing device 300, the image capturing part F330 focuses the camera 304 on the first vehicle 10 and captures an image by the camera 304 (step S23). In the case where the image capture request signal contains information designating capture of a still image or a moving image and/or information designating the angle of image capture, the image capturing part F330 captures an image of the first vehicle 10 in accordance with the designated conditions. When capturing an image of the first vehicle 10, the image capturing part F330 may send a notification of the start of image capture and information about the location of the image capturing device 300 to the first on-vehicle apparatus 100. Then, the first on-vehicle apparatus 100 can inform the user of the first vehicle 10 of the time of image capture and the location of the image capturing device 300. In consequence, the user of the first vehicle 10 can be aware of the time of image capture and the location from which an image is captured.

The data of the image of the first vehicle 10 captured by the image capturing part F330 is sent to the first on-vehicle apparatus 100 by the image sending part F340 (step S24).

By the above-described process according to the flow chart in FIG. 9, the vehicle-image capturing system can capture an image of the first vehicle 10 with the user aboard (e.g. an image of the first vehicle 10 during running) from outside without effort of preparing a photographer or image capturing equipment on the roadside of the route of travel and provide data of the captured image to the user of the first vehicle 10.

As above, the vehicle-image capturing system according to the first modification can provide the advantageous effects same as those of the system according to the first embodiment. Features of the system according to the first modification may be employed in combination with features of the system according to the above-described first embodiment. For example, when there are second vehicles 20 and image capturing devices 300 in the neighborhood of the first vehicle 10, the first on-vehicle apparatus 100 may transmit the image capture request signal to both the second on-vehicle apparatuses 200 and the image capturing devices 300 by broadcast.

### Second Modification of First Embodiment

Next, a second modification of the above-described first embodiment will be described. The components and the processing steps that are substantially the same as those in the first embodiment will not be described in detail.

In the above-described vehicle-image capturing system according to the first embodiment, when receiving an image capture request signal transmitted from the first on-vehicle apparatus 100, the second on-vehicle apparatus 200 automatically captures an image of the first vehicle 10 and sends the data of the captured image. In the system according to the second modification, in contrast, when receiving an image capture request signal transmitted from the first on-vehicle apparatus 100, the second on-vehicle apparatus 200 captures an image of the first vehicle 10 and sends the data of the captured image on condition that the user riding in the second vehicle 20 approves its doing so.

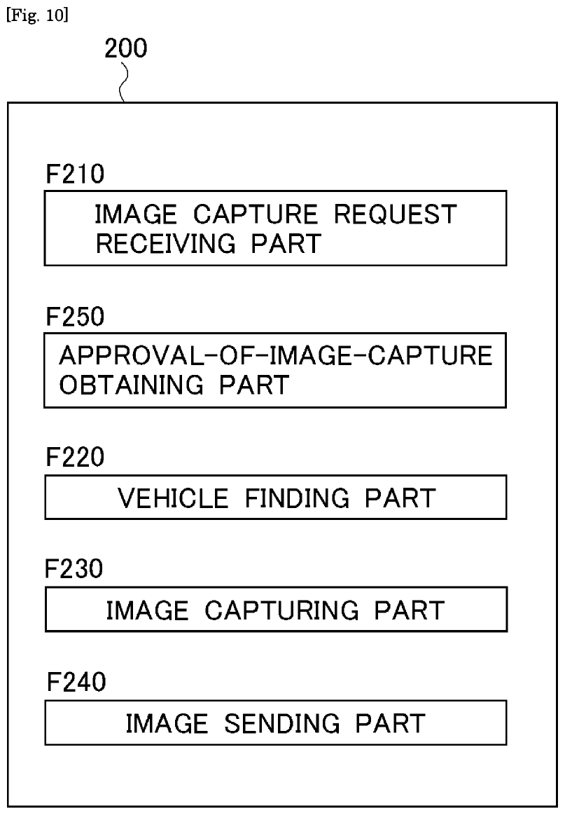

FIG. 10 is a diagram illustrating the functional configuration of the second on-vehicle apparatus 200 in the system according to the second modification of the first embodiment. As illustrated in FIG. 10, the second on-vehicle apparatus 200 in this modification has, as functional components, an approval-of-image-capture obtaining part F250 in addition to the image capture request receiving part F210, the vehicle finding part F220, the image capturing part F230, and the image sending part F240. The approval-of-image-capture obtaining part F250 is implemented by the processor 201 of the second on-vehicle apparatus 200 by executing computer programs on the main storage unit 202 as with the image capture request receiving part F210, the vehicle finding part F220, the image capturing part F230, and the image sending part F240. The approval-of-image-capture obtaining part F250 may be implemented entirely or partly by a hardware circuit. The approval-of-image-capture obtaining part F240 may be implemented entirely or partly by another computer connected to the network N1.

When the image capture request receiving part F210 receives an image capture request signal transmitted from the first on-vehicle apparatus 100, the approval-of-image-capture obtaining part F250 asks the user of the second vehicle 20 whether he or she approves image capture of the first vehicle 10 or not. Specifically, the approval-of-image-capture obtaining part F250 causes the display unit 204 to display a message that prompts the user of the second vehicle 20 to select approval or disapproval of image capture of the first vehicle 10. Moreover, the display unit 204 may display a button for selection of approval and a button for selection of disapproval on a touch panel display. If the user of the second vehicle 20 selects approval of image capture of the first vehicle 10, the vehicle finding part F220, the image capturing part F230, and the image sending part F240 execute their respective processes in the manner same as the first embodiment to carry out the processing of capturing an image of the first vehicle 10 and sending the captured image data. On the other hand, if the user of the second vehicle 20 selects disapproval of image capture of the first vehicle 10, the second on-vehicle apparatus 200 does not perform the processing of capturing an image of the first vehicle 10 and sending the captured image data.

In some situations, for example, when the user of the second vehicle 20 wishes to use the camera 207 for a purpose other than image capture of the first vehicle 10 or to carry out data communications of a relatively large traffic, the system according to this modification allows him or her to prevent the camera 207 from being used for image capture of the first vehicle 10 or prevent the communication line from being used for transmission of the data of an image of the first vehicle 10. This prevents the convenience of the user of the second vehicle 20 from being diminished due to image capture of the first vehicle 10. The first on-vehicle apparatus 100 may send to the second on-vehicle apparatus 200 information about an incentive that will be given to the user of the second vehicle 20 if he or she approves image capture of the first vehicle 10 and transmission of captured image data. The incentive may be, for example, a coupon or points that can be used in payment for shopping, eating and drinking, and/or refueling. This can motivate the user of the second vehicle 20 to approve image capture of the first vehicle 10 and transmission of captured image data.

### Second Embodiment

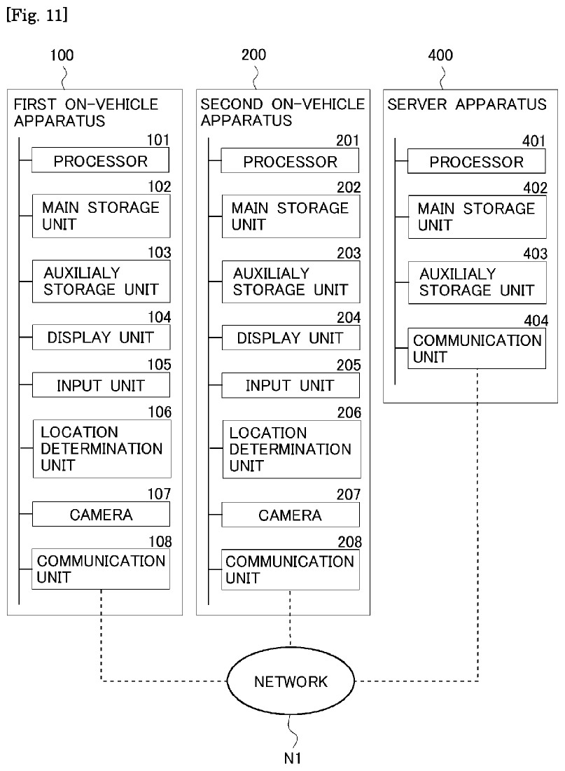

Next, a second embodiment of the present disclosure will be described with reference to FIGS. 11 to 16. In the following, features of the second embodiment that are different from the first embodiment will be described, and the components and the steps of processing that are substantially the same as those in the first embodiment will not be described in detail.

In the system according to the first embodiment, the data of an image of the first vehicle 10 captured by the second on-vehicle apparatus 200 is sent from the second on-vehicle apparatus 200 directly to the first on-vehicle apparatus 100. In the system according to the second embodiment, in contrast, the data of an image of the first vehicle 10 captured by the second on-vehicle apparatus 200 is sent from the second on-vehicle apparatus 200 indirectly via a server apparatus to the first on-vehicle apparatus 100.

(Hardware Configuration)

FIG. 11 is a diagram illustrating the hardware configuration of the components of a vehicle-image capturing system according to the second embodiment. The vehicle-image capturing system according to the second embodiment includes a first on-vehicle 100 provided on a first vehicle 10, a second on-vehicle apparatus 200 provided on a second vehicle 20, and a server apparatus 400.

The server apparatus 400 has a configuration as an ordinary computer. The server apparatus 400 has a processor 401, a main storage unit 402, an auxiliary storage unit 403, and a communication unit 404, which are interconnected by buses. The main storage unit 402 and the auxiliary storage unit 403 are computer-readable recording media. The hardware configuration of the computer is not limited to that illustrated in FIG. 11, but some of its components may be eliminated or replaced, and/or other components may be added.

The processor 401 of the server apparatus 400 loads programs stored in a recording medium into a workspace of the main storage unit 402 and executes the programs to control various functional components. Thus, the server apparatus 400 implements functions for achieving desired purposes.

The processor 401, the main storage unit 402, and the auxiliary storage unit 403 are similar to the processor 101, 201, the main storage unit 102, 202, and the auxiliary storage unit 103, 203 of the first and second on-vehicle apparatuses 100, 200 and will not be described further. The communication unit 404 is used to transmit information between the server apparatus 400 and external apparatuses. The communication unit 404 may include, for example, a LAN (Local Area Network) interface board or a wireless communication circuit for wireless communication. The LAN interface board or the wireless communication circuit is connected to the network N1.

Various processing executed in the server apparatus 400 configured as above may be executed by either hardware or software.

(Functional Configuration of the First On Vehicle Apparatus)

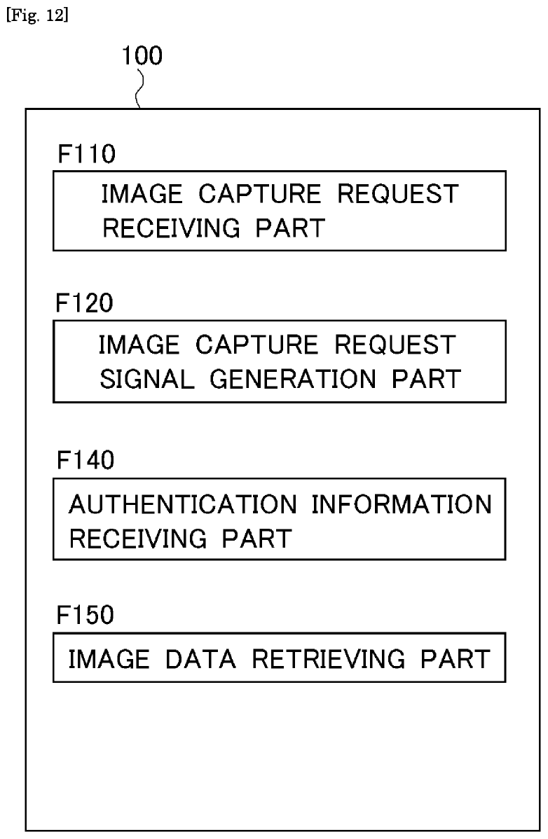

The functional configuration of the first on-vehicle apparatus 100 in the system according to the second embodiment will now be described with reference to FIG. 12. As illustrated in FIG. 12, the first on-vehicle apparatus 100 according to this embodiment has, as functional components, an image capture request receiving part F110, an image capture request signal generation part F120, an authentication information receiving part F140, and an image data retrieving part F150. The first on-vehicle apparatus 100 also includes an image data receiving part F130. The image capture request receiving part F110, the image capture request signal generation part F120, the authentication information receiving part F140, and the image data retrieving part F150 are implemented by the processor 101 of the first on-vehicle apparatus 100 by executing computer programs on the main storage unit 102. One or some of the image capture request receiving part F110, the image capture request signal generation part F120, the authentication information receiving part F140, and the image data retrieving part F150 may be implemented entirely or partly by one or more hardware circuits. One or some of the image capture request receiving part F110, the image capture request signal generation part F120, the authentication information receiving part F140, and the image data retrieving part F150 or a part of the processing of them may be implemented by another computer or other computers connected to the network N1. For example, the processing executed as the image capture request receiving part F110, the processing executed as the image capture request signal generation part F120, the processing executed as the authentication information receiving part F140, and the processing executed as the image data retrieving part F150 may be executed by different computers.

The image capture request receiving part F110 and the image capture request signal generation part F120 are the same as those in the first on-vehicle apparatus 100 according to the first embodiment and will not be described further. The authentication information receiving part F140 receives authentication information created by the second on-vehicle apparatus 200 that will be described later, through the communication unit 108. The authentication information is information that is required when downloading image data of the first vehicle 10 from the server apparatus 400, which will be specifically described later.

The image data retrieving part F150 is configured to download image data of the first vehicle 10 from the server apparatus 400, which will be specifically described later, using the authentication information received by the authentication information receiving part F140. Specifically, for example, the image data retrieving part F150 sends a download request signal containing the authentication information to the server apparatus 400 through the communication unit 108. When the image data associated with the authentication information is sent from the server apparatus 400 in response to the request, the image data retrieving part F150 stores the image data in the auxiliary storage unit 103 or other storage means. The image data retrieving part F150 may be configured to execute the processing of downloading either when it receives a request for download made by the user of the first vehicle 10 or automatically when the authentication information receiving part F140 receives the authentication information. After downloading the image data of the first vehicle 10 from the server apparatus 400, the image data retrieving part F150 may notify the user of the first vehicle 10 of the completion of downloading.

(Functional Configuration of the Second On-Vehicle Apparatus)

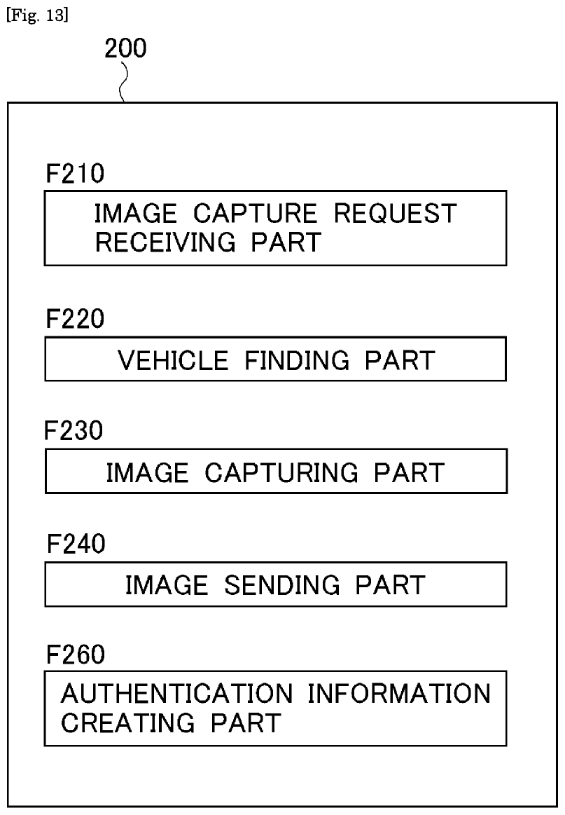

The functional configuration of the second on-vehicle apparatus 200 in the system according to the second embodiment will now be described with reference to FIG. 13. As illustrated in FIG. 13, the second on-vehicle apparatus 200 according to the second embodiment has, as functional components, an image capture request receiving part F210, a vehicle finding part F220, an image capturing part F230, an image sending part F240, and an authentication information creating part F260. The image capture request receiving part F210, the vehicle finding part F220, the image capturing part F230, the image sending part F240, and the authentication information creating part F260 are implemented by the processor 201 of the second on-vehicle apparatus 200 by executing computer programs on the main storage unit 202. One or some of the image capture request receiving part F210, the vehicle finding part F220, the image capturing part F230, the image sending part F240, and the authentication information creating part F260 may be implemented entirely or partly by one or more hardware circuits. One or some of the image capture request receiving part F210, the vehicle finding part F220, the image capturing part F230, the image sending part F240, and the authentication information creating part F260 or a part of the processing of them may be implemented by another computer or other computers connected to the network N1. For example, the processing executed as the image capture request receiving part F210, the processing executed as the vehicle finding part F220, the processing executed as the image capturing part F230, the processing executed as the image sending part F240, and the processing executed as the authentication information creating part F260 may be executed by different computers.

The image capture request receiving part F210, the vehicle finding part F220, and the image capturing part F230 are the same as those in the second on-vehicle apparatus 200 in the system according to the first embodiment and will not be described further. When the image capturing part F230 captures an image of the first vehicle 10, the authentication information creating part F260 creates authentication information linked with the image data of the first vehicle 10. As described before, the authentication information is information that is required when downloading image data of the first vehicle 10 from the server apparatus 400, which will be specifically described later.

The image sending part F240 sends data of the image of the first vehicle 10 captured by the image capturing part F230 and the authentication information created by the authentication information creating part F260 to the server apparatus 400 through the communication unit 208. Moreover, the image sending part F240 sends the authentication information created by the authentication information creating part F260 also to the first on-vehicle apparatus 100 through the communication unit 208.

(Functional Configuration of the Server Apparatus)

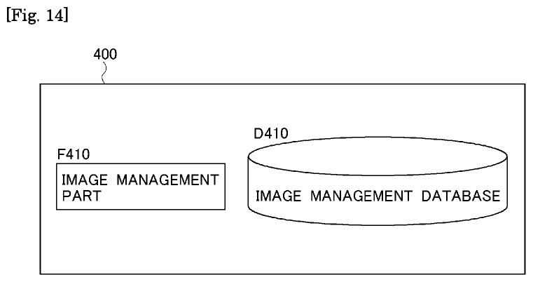

Next, the functional configuration of the server apparatus 400 will be described with reference to FIG. 14. As illustrated in FIG. 14, the server apparatus 400 in the system according to the second embodiment has, as functional components, an image management part F410 and an image management database D410. The image management part F410 is implemented by the processor 401 of the server apparatus 400 by executing a computer program on the main storage unit 402. The image management part F410 may be implemented entirely or partly by a hardware circuit. The processing of the image management part F410 may be implemented partly by another computer connected to the network N1. The image management database D410 is created by a database management system program (DBMS program) executed by the processor 401 of the server apparatus 400 by managing data stored in the auxiliary storage unit 403. The image management database D410 is, for example, a relational database.

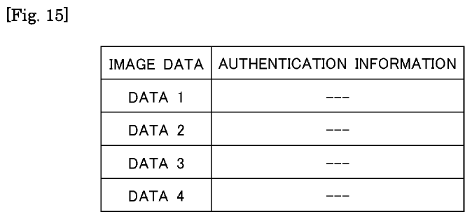

In the image management database D410, the image data of each first vehicle 10 is linked with the authentication information. An exemplary structure of information stored in the image management database D410 will now be described with reference to FIG. 15. FIG. 15 illustrates an exemplary table structure of information stored in the image management database D410. The structure of the table stored in the image management database D410 (which will also be referred to as “image information table” hereinafter) is not limited to that illustrated in FIG. 15, but some fields may be added, changed, or removed fitly.

The image information table illustrated in FIG. 15 has the field of image data and the field of authentication information. What is stored in the image data field is data acquired by capturing an image of the first vehicle 10. What is stored in the authentication information field is the authentication information linked with the corresponding image data.

Referring back to FIG. 14, when the image management part F410 receives the image data of the first vehicle 10 and the authentication information associated with it from the second on-vehicle apparatus 200, it stores them in the image management database D410 with the image data and the authentication information being linked with each other. When the image management part F410 receives a download request containing authentication information from the first on-vehicle apparatus 100, it accesses the image management database D410 to extract the image data linked with the authentication information. Moreover, the image management part F410 sends the extracted image data to the first on-vehicle apparatus 100 through the communication unit 404.

(Procedure of Processing)

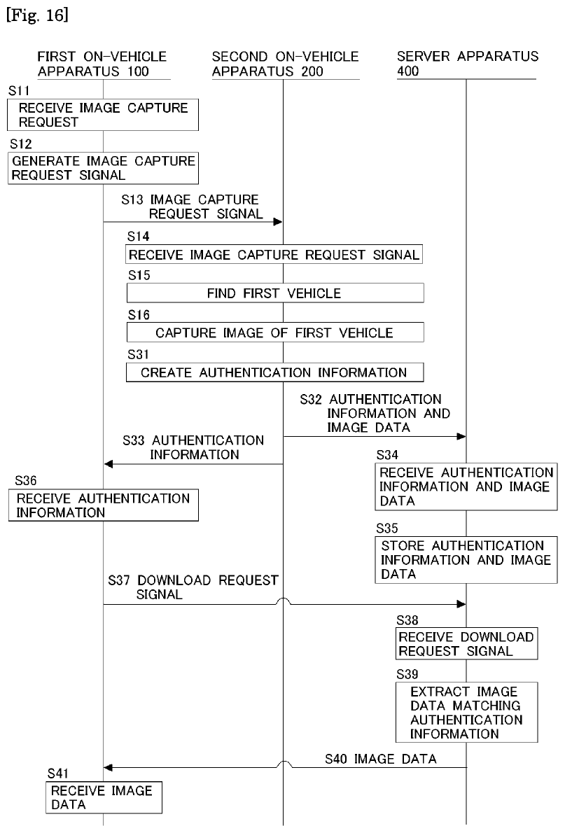

The procedure of processing performed by the first on-vehicle apparatus 100, the second on-vehicle apparatus 200, and the server apparatus 400 in the system according to the second embodiment will now be described with reference to FIG. 16. FIG. 16 is a flow chart illustrating flows of data transmitted between the components of the vehicle-image capturing system and processing performed by them. In FIG. 16, the steps of processing that are the same as those in the flow chart in FIG. 5 are denoted by the same reference signs and will not be described further.

Referring FIG. 16, when the image capturing part F230 of the second on-vehicle apparatus 200 captures an image of the first vehicle 10 using the camera 207 (step S16), the authentication information creating part F260 creates authentication information associated with image data of the first vehicle 10 (step S31). The authentication information created by the authentication information creating part F260 is sent to the server apparatus 400 with the image data of the first vehicle 10 (step S32). The authentication information created by the authentication information creating part F260 is sent also to the first on-vehicle apparatus 10 through the communication unit 208 (step S33).

When the communication unit 404 of the server apparatus 400 receives the image data of the first vehicle 10 and the authentication information associated therewith (step S34), the image management part F410 of the server apparatus 400 stores them in the image management database D410 with the image data of the first vehicle 10 and the authentication information being linked with each other (step S35).

When the communication unit 108 of the first on-vehicle apparatus 100 receives the authentication information (step S36), the image data retrieving part F150 of the first on-vehicle apparatus 100 sends a download request signal containing the authentication information to the server apparatus 400 through the communication unit 108 (step S37). In this connection, as described above, the image data retrieving part F150 may be configured to send the download request signal either when it receives a request for download made by the user of the first vehicle 10 or automatically when the authentication information receiving part F140 receives the authentication information.

When the communication unit 404 of the server apparatus 400 receives the download request signal sent from the first on-vehicle apparatus 100 (step S38), the image management part F410 accesses the image management database D410 on the basis of the authentication information contained in the download request signal to extract the image data linked with this authentication information (step S39). The extracted image data is sent to the first on-vehicle apparatus 100 through the communication unit 404 (step S40). Thus, the image data sent from the server apparatus 400 is received by the communication unit 108 of the first on-vehicle apparatus 100.

By the process according to the flow chart of FIG. 16, the data of the image of the first vehicle 10 captured by the second on-vehicle apparatus 200 is delivered to the first on-vehicle apparatus 100 from the second on-vehicle apparatus 200 via the server apparatus 400. This can make the amount of data transmitted between the first on-vehicle apparatus 100 and the second on-vehicle apparatus 200 small. Therefore, it is possible to provide the image data of the first vehicle 10 to the user of the first vehicle 10 even if the first vehicle 10 and/or the second vehicle 20 is located outside the areas in which broadband, high-speed wireless communications are available.

As above, the vehicle-image capturing system according to the second embodiment can capture an image of the first vehicle 10 with the user aboard with high efficiency and provide the data of the captured image to the user of the first vehicle 10 with improved reliability.

### First Modification of Second Embodiment

The above-described vehicle-image capturing system according to the second embodiment uses the camera 207 provided on the second vehicle 20 at a location near the first vehicle 10 to capture an image of the first vehicle 10 from outside. Alternatively, the vehicle-image capturing system may use an image capturing device 300 provided on the side of the road that the first vehicle 10 travels or at a location from which an image of the first vehicle 10 can be captured to capture an image of the first vehicle 10 from outside. In this case, the image capturing device 300 may provide image data of the first vehicle 10 to the first on-vehicle apparatus 100 via the server apparatus 400, as with the second on-vehicle apparatus 200 in the system according to the above-described second embodiment.

### Second Modification of Second Embodiment

In the above-described vehicle-image capturing system according to the second embodiment, when receiving an image capture request signal transmitted from the first on-vehicle apparatus 100, the second on-vehicle apparatus 200 automatically captures an image of the first vehicle 10 and executes the processing of sending the data of the captured image. Alternatively, as in the second modification of the first embodiment, the second on-vehicle apparatus 200 may be configured to capture an image of the first vehicle 10 and execute the processing of sending the data of the captured image on condition that the user riding in the second vehicle 20 approves its doing so.

### <Others>

The above embodiments and their modifications have been described only by way of example. Modifications can be made to the above embodiments without departing from the essence of the present disclosure.

The processing and means that have been described in the foregoing may be employed in any combination so long as it is technically feasible to do so. One, some, or all of the processes according to the embodiments that have been described as processes performed by one apparatus may be performed by a plurality of apparatuses in a distributed manner. One, some, or all of the processes according to the embodiments that have been described as processes performed by different apparatuses may be performed by a single apparatus. The hardware configuration employed to implement various functions in a computer system may be modified flexibly.

The present disclosure can be carried out by supplying a computer program(s) that implements the functions described in the above description of the embodiments to a computer to let one or more processors of the computer read and execute the program(s). Such a computer program(s) may be supplied to the computer by a non-transitory, computer-readable storage medium that can be connected to a system bus of the computer, or through a network. The non-transitory, computer-readable storage medium refers to a recording medium that can store information, such as data and programs, electrically, magnetically, optically, mechanically, or chemically in such a way as to allow the computer or the like to read the stored information. Examples of the non-transitory, computer-readable storage medium include any type of disc media including a magnetic disc, such as a floppy disc (registered trademark) and a hard disk drive (HDD), and an optical disc, such as a CD-ROM, a DVD and a Blu-ray disc. The non-transitory, computer-readable storage medium may include other storage media, such as a read-only memory (ROM), a random access memory (RAM), an EPROM, an EEPROM, a magnetic card, a flash memory, an optical card, and a solid state drive (SSD).

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. A vehicle-image capturing system comprising:
a communication device provided on a first vehicle and configured to execute the processing of receiving an image capture request that requests capture of an image of the first vehicle and transmitting an image capture request signal containing information for identification of the first vehicle and information requesting capture of an image of the first vehicle to the outside of the first vehicle; and
an image capture device provided outside the first vehicle and configured to execute the processing of receiving the image capture request signal, finding the first vehicle on the basis of the information for identification of the first vehicle contained in the image capture request signal, capturing an image of the first vehicle found, and sending the data of the captured image of the first vehicle to the communication device.

2. A vehicle-image capturing system comprising:
a communication device provided on a first vehicle and configured to execute the processing of receiving an image capture request that requests capture of an image of the first vehicle and transmitting an image capture request signal containing information for identification of the first vehicle and information requesting capture of an image of the first vehicle to the outside of the first vehicle; and
an image capture device provided outside the first vehicle and configured to execute the processing of receiving the image capture request signal, finding the first vehicle on the basis of the information for identification of the first vehicle contained in the image capture request signal, capturing an image of the first vehicle found, sending the data of the captured image of the first vehicle to a predetermined server apparatus, and sending authentication information that is needed to retrieve the data of the image sent to the server apparatus to the communication device.

3. A vehicle-image capturing system according to claim 1, wherein the image capturing device is configured to further execute the processing of sending information about the time when image capture of the first vehicle will be performed to the communication device, and the communication device is configured to further execute the processing of informing an occupant of the first vehicle of the time when image capture of the first vehicle will be performed on the basis of the information about the time when image capture of the first vehicle will be performed.

4. A vehicle-image capturing system according to claim 2, wherein the image capturing device is configured to further execute the processing of sending information about the time when image capture of the first vehicle will be performed to the communication device, and the communication device is configured to further execute the processing of informing an occupant of the first vehicle of the time when image capture of the first vehicle will be performed on the basis of the information about the time when image capture of the first vehicle will be performed.

5. A vehicle-image capturing system according to claim 1, wherein the image capturing device is configured to further execute the processing of sending information about the location of the image capturing device to the communication device, and the communication device is configured to further execute the processing of informing an occupant of the first vehicle of the location of the image capturing device on the basis of the information about the location of the image capturing device.

6. A vehicle-image capturing system according to claim 2, wherein the image capturing device is configured to further execute the processing of sending information about the location of the image capturing device to the communication device, and the communication device is configured to further execute the processing of informing an occupant of the first vehicle of the location of the image capturing device on the basis of the information about the location of the image capturing device.

7. A vehicle-image capturing system according to claim 1, wherein the image capture request signal further contains at least one of information designating image capture of a moving image or a still image and information designating an angle of image capture.

8. A vehicle-image capturing system according to claim 2, wherein the image capture request signal further contains at least one of information designating image capture of a moving image or a still image and information designating an angle of image capture.

9. A vehicle-image capturing system according to claim 1, wherein the image capturing device is provided on a second vehicle other than the first vehicle.

10. A vehicle-image capturing system according to claim 2, wherein the image capturing device is provided on a second vehicle other than the first vehicle.

11. A vehicle-image capturing system according to claim 1, wherein the image capturing device is provided on the side of a road that the first vehicle travels.

12. A vehicle-image capturing system according to claim 2, wherein the image capturing device is provided on the side of a road that the first vehicle travels.
